(19) United States
(12) Patent Application Publication
(10) Pub. No.: US 2024/0092039 A1
(43) Pub. Date: Mar. 21, 2024

(54) Winding Apparatus for Producing Fiber-Reinforced Components

(71) Applicant: Mercedes-Benz Group AG, Stuttgart (DE)

(72) Inventors: Niklas MINSCH, Unterensingen (DE); Tim ZANKER, Nufringen (DE); Peter GRAUPNER, Untergruppenbach (DE)

(21) Appl. No.: 18/263,024

(22) PCT Filed: Dec. 8, 2021
(86) PCT No.: PCT/EP2021/084753

§ 371 Date: Jul. 26, 2023

(30) Foreign Application Priority Data
Feb. 5, 2021 (DE) 10 2021 000 599.6

(51) Int. Cl. B29C 70/38; B65H 54/00

(52) U.S. Cl. CPC B29C 70/384; B65H 54/00; B25J 15/0019

(57) ABSTRACT

A winding apparatus for producing a fiber-reinforced component by a three-dimensional winding process includes a robot arm having at least two winding heads. The at least two winding heads are attached next to each other or above each other on the robot arm and are each associated with a respective holder for receiving a respective winding support that a respective fiber strand is windable around to form the component. The respective holders are arranged next to each other on a conveyor device and have a winding position for winding with the respective fiber strand and a mounting position for mounting the respective holders before a winding process and for removing the respective holders after the winding process.

### BACKGROUND AND SUMMARY OF THE INVENTION

The invention relates to a winding apparatus for producing fiber-reinforced components by means of a three-dimensional winding process, comprising a robot arm having at least one winding head which comprises at least one supply spool for a fiber strand as well as an impregnating unit, by means of which the fiber strand can be guided and can be impregnated with resin, as well as at least one holder for receiving a winding support that the fiber strand can wind around to form the component.

The German patent DE 691 09 819 T2 describes a machine for winding and winding tubular sleeves made of elastomeric material containing cord elements, reinforcing fibers and the like, with—a holding and actuating device which acts on a cylindrical matrix on which the sleeve is formed and rotates it around a horizontal axis,—a winding unit which is slidingly engaged with at least one reinforcing fiber thread and which engages it during the rotation of the matrix evenly distributed over the matrix,—a winding unit placed on the matrix for the purpose of feeding at least one layer of elastomeric material so that it is wound onto the matrix after the rotation of the matrix, characterized by—a winding station supporting the winding unit and equipped with a first device holding and rotating the matrix,—a winding station which supports the winding unit and is equipped with a second device which holds and rotates the matrix,—a rotating platform arranged in such a way that it engages on several dies at the respective connecting sockets distributed in the circumferential direction of the platform itself according to a predetermined angle pitch, the platform being able to be rotated around a vertical axis corresponding to an angle pitch, which is equal to the distribution division of the connection sockets,—a first transport element which can be moved from a first operating position, in which it attacks one of the matrices supported by the platform, to a second operating position, in which the matrix on which it attacks is arranged sideways and parallel to another matrix supported by the winding station,—a first tilting element acting between the winding station and the first transport element in the second operating position in order to attack the dies held by the winding station and by the first transport element itself and to change their common position by means of a 180° tilting movement,—a second transport element consisting of a first operating position in which it attacks the matrix, which has previously been processed in the winding station and deposited on the platform by the first transport element, can be moved to a second operating position in which the matrix is arranged laterally and parallel to another matrix supported by the winding station.

The German patent application DE 24 23 914 A1 describes a machine for the production of tubes, characterized by a turret like a revolver head and several tubes radially extending from it, wherein the turret is rotatable with the spindles, so that the spindles pass through several workstations during operation and each spindle can be rotated around its longitudinal axis.

The German patent application DE 34 40 740 A1 describes a device for the production of tubular components made of fiber-reinforced plastic, with a device whereby fiber strands are impregnated with a thermosetting binder, with at least one winding mandrel which can be clamped into a winding machine, on which the impregnated fiber strands are placed, wherein the winding machine has a guide device for the chamfer strand to be wound which can be moved back and forth parallel to the mandrel, a transport device by means of which the wound components are transported by means of a hardening furnace to a device for pulling out the winding mandrels from the hardened components and to at least one post-processing station, and with which the empty winding mandrels are transported back to the winding station via a mandrel preparation station, characterized by the fact that the post-processing station is provided between the hardening furnace and the mandrel pull-out device.

Such a winding apparatus is known from DE 10 2017 005 754 A1, wherein a robot arm with a winding head is surrounded by an octagonal holder for receiving eight winding supports. The winding supports are wound one after the other, wherein the robot arm keeps rotating from one winding support to the next after completing a winding.

A method for the production of a fiber composite component that can be produced by means of such a winding apparatus is presented in DE 10 2013 014 032 A1. It is disadvantageous that the productivity and application of such winding apparatuses is relatively low, because a winding process requires quite some time and the components can only be produced one after the other on such an apparatus.

It is the object of the invention to provide a winding apparatus that enables a higher throughput of identically-constructed components that are created.

The object is solved in that at least two winding heads are attached next to each other on the robot arm and every winding head is associated with a holder for receiving a winding support, wherein the holders are arranged next to or above each other on a conveyor device having two positions, namely a winding position for winding with the fiber strand and a mounting position for mounting the holders before the winding process and for removing them after the winding process.

At least two identically-constructed components can thereby be wound in parallel because the robot arm with the winding heads executes the same movement for winding the winding supports. According to the invention, it is possible to produce not only two, rather also significantly more components simultaneously in parallel. To this end, the winding heads and, in the same arrangement, the same number of winding supports are arranged in a horizontal or vertical row or a matrix. In order to, for example, produce ten components simultaneously, two rows each with five winding heads can, for example, be attached to the robot arm. After finishing the winding process, the conveyor device on which the winding supports are fixed is moved such that the wound winding supports move from the winding position into the mounting position, where the winding supports are manually or, preferably, automatically removed. After removing the wound winding supports, new winding supports are manually or, preferably, automatically attached to the conveyor device and then brought out of this mounting position back into the winding position facing the robot arm with the winding heads, where a renewed winding process is begun.

According to an advantageous embodiment of the invention, the at least three winding heads are arranged in a row next to or above each other. A larger number of winding heads can be arranged next to each other, wherein the number is only limited by mechanical and dynamic considerations, but at least 10 parallel winding heads are conceivable in the context of the invention. However, it is more expedient to arrange several rows of winding heads in several rows in the form of a matrix, for example 2 or 3 rows each with 5 winding heads and, of course, a corresponding number of holders for fastening winding supports.

According to an advantageous development of the invention, the winding position and the mounting position are arranged on two opposite sides of the conveyor device. In this manner, it is possible to wind the winding supports attached to the holders in the winding position and, in the same arrangement, to remove them on the rear side. The conveyor device is therefore formed such that these winding supports are mounted or removed on one side and simultaneously wound on the other side. The conveyor device can comprise a rail-like or strip-like guide along which the holders can be moved from the mounting position into the winding position and back. The conveyor device can, alternatively, be formed as a rectangular frame that has holders on two opposite sides and is rotatable by 180° around a horizontal or vertical axis, in order to bring the holders from one position into the other.

According to an advantageous development of the invention, the conveyor device comprises an endless belt, which is guided over two deflection devices, and the winding position and the mounting position of the holders are arranged on the two sides of the endless conveyor device that are opposite in relation to the deflection devices. By means of such a “paternoster” arrangement, the winding process can occur on one side of the conveyor device, while on the other side, fully wound blanks can simultaneously be removed for curing and new winding supports can be mounted.

According to an advantageous development of the invention, the holders of the winding supports comprise degrees of freedom that can be moved by a motor, preferably as rotational degrees of freedom in the form of joints and/or also translational degrees of freedom. Joints on the holder side cause an improved and accelerated winding of the winding supports, because a part of the necessary relative movement between the winding heads and the winding supports during the winding process is taken over by means of the joints of the winding supports. The moved masses of the winding heads therefore become smaller, whereby the winding process can be carried out faster.

According to an advantageous development of the invention, the winding apparatus has a handling robot for mounting and removing the winding supports on the mounting side of the conveyor device. Such a handling robot can remove the created wound winding supports one after the other and can replace them with new, unwound winding supports. It is also possible to provide a removing device that removes all wound winding supports together. For the purpose of receiving the wound winding supports, multi-part moulds can also be provided which surround the wound winding supports in order to define the external shape of the workpiece to be completed and the closed moulds are then removed from the holders.

Further advantages, features and details arise from the following description in which an exemplary embodiment is described in detail, with reference to the drawings. The same, similar and/or functionally identical parts are referred to with the same reference numerals.

### BRIEF DESCRIPTION OF THE DRAWINGS

FIG. 1 shows a schematic side view of a winding apparatus according to the invention; and

FIG. 2 shows a schematic representation of a second embodiment for a conveyor device.

### DETAILED DESCRIPTION OF THE DRAWINGS

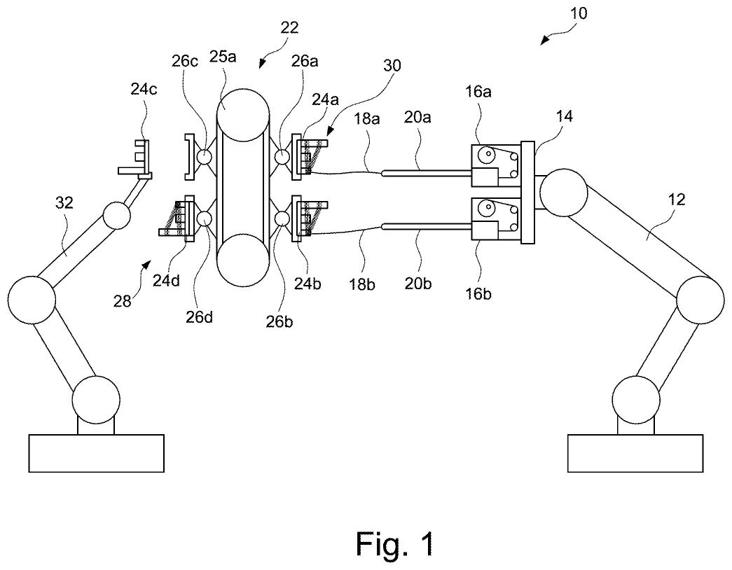

The winding apparatus 10 according to FIG. 1 comprises an articulated arm robot 12 having several arm members, on the handling end of which a support structure 14 is attached, on which a number of winding heads 16a, 16b are mounted. These winding heads 16a, 16b each comprise at least one fiber spool and an impregnating unit through which at least one fiber strand or roving 18a, 18b wound up on the fiber spool runs while liquid resin is admixed. Several fiber spools can be provided, so that several fiber strands are combined to form one fiber strand 18a, 18b in the impregnating unit and leave via a fiber placement pipe 20a, 20b.

In FIG. 1, the winding apparatus 10 is shown in a side view and two winding heads 16a, 16b are represented. In the context of the invention, there can be two rows of winding heads 16a, 16b arranged next to each other, i.e., several further winding heads (not shown) can be arranged behind the winding head 16a.

A winding support holding device 22 which serves to provide, to hold and to exchange a number of winding supports 24a, 24b for winding the rovings or fiber strands 18a, 18b is arranged in front of the articulated arm robot 12. The winding support holding device 22 comprises a conveyor device 25a having a number of holders 26a, 26b for holding and fixing the winding supports 24a, 24b. The holders 26a, 26b can have several rotational or translational degrees of freedom, in order to change the position of the winding supports 24a, 24b in the space and therefore to simplify and to accelerate a winding process.

The number and arrangement of the winding supports 24a, 24b and holders 26a, 26b corresponds to that of the winding heads 16a, 16b, so that the winding processes all take place in parallel to each other. Provided that the holders 26a, 26b have degrees of freedom of movement, these will, of course, also all be automatically moved synchronously to each other.

For the holders 26a, 26b on the winding support holding device 22 or the conveyor device 25a, two positions are provided, namely a mounting position 28 and a winding position 30 arranged on the opposite side, facing the articulated arm robot 12. When forming the conveyor device 25 as a paternoster-type endless conveyor device, an activation of the conveyor device 25 leads to a number of holders 26c, 26d—then with unwound winding supports 24c, 24d—being moved out of the mounting position 28 into the winding position 30, while the same number of holders 26a, 26b with wound winding supports 24a, 24b are, conversely, simultaneously moved out of the winding position 30 into the mounting position 28.

A handling robot 32 is arranged on the side of the winding support holding device 22 facing the mounting position 28, wherein it is, in turn, preferably a multi-joint robot. The handling robot 32 serves to remove already-wound winding supports 24d for curing the resin as well as for mounting unwound winding supports 24c.

During operation, the handling robot 32 will attach fresh, unwound winding supports 24c to the holders 26c, 26d on the mounting side of the winding support holding device 22. Then, the conveyor device 25a moves the holders 26c, 26d on the opposite side into the winding position 30. Then, the free ends of the fiber strands 18a, 18b are attached to the winding supports (henceforth reference numerals 24a, 24b) and the articulated arm robot 12 begins to carry out a predetermined winding program, i.e., it moves the winding heads 16a, 16b such that the tips of the fiber placement pipes 20a, 20b are moved around structures formed on the winding supports 24a, 24b, wherein the fiber strands 18a, 18b are pulled out of the winding heads 16a, 16b and through the fiber placement pipes 20a, 20b by means of the tension exerted. Insofar as the holders 26a, 26b have corresponding degrees of freedom, they are moved parallel and synchronously and in interaction with the movements of the fiber placement pipes 20a, 20b, in order to accelerate or improve the winding process. After finishing a winding process, the fiber strands 18a, 18b are trimmed on the mounting side. Alternatively, it is possible to provide one device per winding support 24, 24b on the winding side, which separates the fiber strands 18a, 18b after ending the winding process, and to fix the ends of the fiber strands 18a, 18b to the unwound winding supports after exchanging the wound winding supports for unwound winding supports, so that the predetermined winding program can subsequently be carried out again.

Simultaneously with the winding process, the holders 26c, 26d on the mounting side 28 are loaded with unwound winding supports 26c by means of the handling robot 32.

If the winding process is completed, then the conveyor device 25a is put into motion, whereby the wound winding supports 24a, 24b are moved out of the winding position 30 into the mounting position 28, while the unwound winding supports 26c are simultaneously moved out of the mounting position 28 into the winding position 30. An exchange of the wound 24d with the unwound winding supports 24c occurs by means of the handling robot 32, while the winding supports 24a, 24b located in the winding position 30 are simultaneously wound.

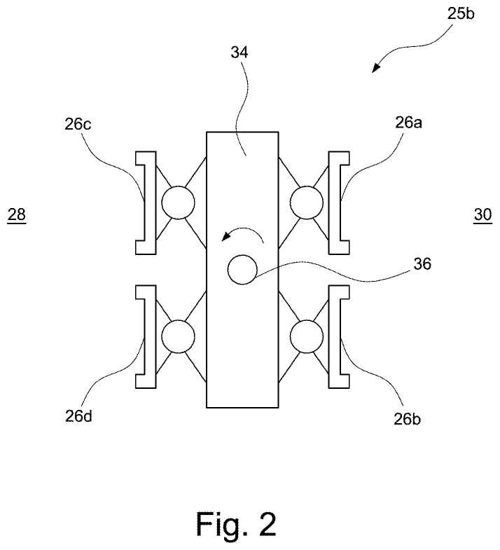

In FIG. 2, a second embodiment of the conveyor device 25b is represented, which comprises a frame 34 that is rotatable around an axis of rotation 36. A horizontal axis of rotation 36 is represented in FIG. 2, however this can also be orientated vertically in the context of the invention. By means of rotating the frame 34 by 180°, the holders 26a, 26b are moved out of the winding position 30 on the mounting side 28 and the holders 26c, 26c are moved from the mounting position 28 into the winding position 30.

Although the invention has been illustrated and described in more detail by a preferred exemplary embodiment, the invention is not restricted by the disclosed examples and other variations may be derived therefrom by the person skilled in the art without leaving the scope of the invention. It is therefore clear that there is a plurality of possible variations. It is also clear that embodiments stated by way of example are only really examples which are not to be seen as limiting the scope, application possibilities or configuration of the invention in any way. Instead, the preceding description and the description of the figures enable the person skilled in the art to concretely implement the exemplary embodiments, whereby the person skilled in the art, having knowledge of the disclosed inventive idea, can undertake various changes, for example with regard to the function or arrangement of individual elements mentioned in an exemplary embodiment without leaving the scope of the invention, which is defined by the claims and their legal equivalents, such as further explanations in the description.

1-9. (canceled)

10. A winding apparatus (10) for producing a fiber-reinforced component by a three-dimensional winding process, comprising:
a robot arm (12) having at least two winding heads (16a, 16b), wherein the at least two winding heads (16a, 16b) each have a respective supply spool for a respective fiber strand (18a, 18b) and a respective impregnating unit via which the respective fiber strand (18a, 18b) is guidable and is impregnatable with resin;
wherein the at least two winding heads (16a, 16b) are attached next to each other or above each other on the robot arm (12) and are each associated with a respective holder (26a, 26b, 26c, 26d) for receiving a respective winding support (24a, 24b, 24c, 24d) that the respective fiber strand (18a, 18b) is windable around to form the component;
wherein the respective holders (26a, 26b, 26c, 26d) are arranged next to each other on a conveyor device (25) and have a winding position (30) for winding with the respective fiber strand (18a, 18b) and a mounting position (28) for mounting the respective holders (26a, 26b, 26c, 26d) before a winding process and for removing the respective holders (26a, 26b, 26c, 26d) after the winding process.

11. The winding apparatus (10) according to claim 10, wherein the robot arm (12) has at least three winding heads (16a, 16b) that are arranged in a row next to each other or above each other.

12. The winding apparatus (10) according to claim 10, wherein a number of the winding heads (16a, 16b) are arranged in a form of a matrix in two or more parallel rows.

13. The winding apparatus (10) according to claim 10, wherein the winding position (30) and the mounting position (28) are arranged on two opposite sides of the conveyor device (25).

14. The winding apparatus (10) according to claim 10, wherein the conveyor device (25) comprises an endless belt which is guided over two deflection devices and wherein the winding position (30) and the mounting position (28) are arranged on two sides of the conveyor device (25) that are opposite in relation to the two deflection devices.

15. The winding apparatus (10) according to claim 10, wherein the respective holders (26a, 26b, 26c, 26d) have degrees of freedom that can be moved by a motor.

16. The winding apparatus (10) according to claim 15, wherein the degrees of freedom are formed as joints having one, two or three rotational degrees of freedom.

17. The winding apparatus (10) according to claim 15, wherein the degrees of freedom comprise one or two translational degrees of freedom.

18. The winding apparatus (10) according to claim 10, further comprising a handling robot (32) for mounting and removing the winding supports (24a, 24b, 24c, 24d) on the mounting side (28) of the conveyor device (25).
